(19) United States
(12) Patent Application Publication
(10) Pub. No.: US 2017/0080590 A1
(43) Pub. Date: Mar. 23, 2017

(54) FOOD SLICER

(71) Applicant: Prince Castle LLC, Carol Stream, IL (US)

(72) Inventors: Eugene S. Maslana, Arlington Heights, IL (US); Eric Larson, Pecatonica, IL (US); Karl Heinze, West Chicago, IL (US)

(73) Assignee: Prince Castle LLC, Carol Stream, IL (US)

(21) Appl. No.: 15/267,730

(22) Filed: Sep. 16, 2016

Related U.S. Application Data
(60) Provisional application No. 62/221,363, filed on Sep. 21, 2015.

(51) Int. Cl. B26D 7/26; B26D 3/26; B26D 7/01

(52) U.S. Cl. CPC B26D 7/2614; B26D 7/01; B26D 3/26; B26D 2210/02; B26D 2007/0018

(57) ABSTRACT

A slicer includes a base and a head. The base includes a plurality of fins extending upwards from the base. The head defines an open interior and is moveable about the plurality of fins to receive the plurality of fins within the open interior of the head. A blade set includes a plurality of blades. The blade set is positioned within the open interior of the head to be received between the plurality of fins when the plurality of fins are received within the open interior of the head. A slicing system includes a safety comb removably secured to the blade set. The safety comb includes a plate and a plurality of fingers that extend away from the plate. The plurality of fingers are adapted to extend between blades of the blade set.

### CROSS REFERENCE TO RELATED APPLICATION

The present application claims priority of U.S. Provisional Patent Application No. 62/221,363, filed on Sep. 21, 2015, the contents of which are hereby incorporated herein by reference in their entirety.

### FIELD OF THE DISCLOSURE

The present disclosure is related to the field of slicing. More specifically, the present application is related to a slicer for food.

### BACKGROUND

Restaurant and food preparation industries require a large volume of produce to be processed such as by slicing so that the sliced produce can be used in food preparation and assembly. In addition to rapid slicing of produce, food preparation requires consistently sliced produce such that the food prepared with that produce is consistent in appearance, taste, texture, portion size, and cooking qualities between servings prepared.

Produce slicing is typically a manually performed task due to the aforementioned desire for consistency. As slicing necessarily requires some form of blade or cutting surface, this naturally involves a desire to seek solutions to improve safety for food preparation workers. Currently available slicing solutions have exposed blade sets which can present a risk to users during set up and operation.

### BRIEF DISCLOSURE

An exemplary embodiment of a slicer includes a base and a head. The base includes a plurality of fins that extend upwards from the base. The head defines an open interior and is moveable about the plurality of fins to receive the plurality of fins within the open interior of the head. A blade set includes a plurality of blades. The blade set is positioned within the open interior of the head and is received between the plurality of fins when the plurality of fins are received within the head.

In a further exemplary embodiment, the slicer additionally includes a first handle, a second handle, a first tube projection, and a second tube projection. A first finger cavity is defined between the first handle and the first tube projection. A second finger cavity is defined between the second handle and the second tube projection.

In a further exemplary embodiment of the slicer, the blade set is positioned at an angle within the open interior of the head. The blade set is positioned within the open interior of the head with a first end of the blade set positioned within the first tube projection and a second end of the blade set positioned within the second handle.

An exemplary embodiment of a slicing system includes a slicer which includes a base and a head. The base includes a plurality of fins extending upwards from the base. The head defines an open interior and is moveable about the plurality of fins to receive the plurality of fins within the open interior of the head. A blade set includes a plurality of blades. The blade set is removably received within the open interior of the head at a position to be received between the plurality of fins when the plurality of fins are received within the open interior of the head. A safety comb is removably secured to the blade set. The safety comb includes a plate and a plurality of fingers extending away from the plate and adapted to extend between blades of the blade set.

In a further exemplary embodiment, the slicing system additionally includes at least one front latch that extends forward of the safety comb from at least one finger of the safety comb. The safety comb includes at least one rear latch that extends rearward of the safety comb from at least one finger of the safety comb. The safety comb is configured to be removably secured to the blade set by engagement of the at least one front latch and at least one rear latch to the blade set. The at least one front latch is oriented in a direction in which the blade set is to be removed. In a further exemplary embodiment of a slicing system, the slicing system additionally includes at least one finger with a latch end included in the head. The latch end of the at least one finger is configured to releaseably secure to the blade set to retain the blade set within the head. Fingers of the safety comb adjacent to at least one rear latch of the safety comb engage and deform the at least one finger with the latch end of the head to disengage the latch end from the blade set to facilitate removal of the blade set from the head.

### BRIEF DESCRIPTION OF THE DRAWINGS

FIG. 1 is a perspective view of an exemplary embodiment of a slicer in a closed position.

FIG. 2 is a perspective view of an exemplary embodiment of the slicer in an open position.

FIG. 3 is a perspective view of an exemplary embodiment of a slicer head during installation or removal of a blade set.

FIG. 4 is a perspective view of an exemplary embodiment of a safety comb.

FIG. 5A depicts the safety comb installed on the blade set for insertion of the blade set into the head.

FIG. 5B depicts the safety comb installed in the blade set for removal of the blade set from the head.

FIG. 6 is a sectional view taken along line 6-6 of FIG. 1.

FIG. 7 is a sectional view taken along line 7-7 of FIG. 1.

FIG. 8 is a top view of the slicer with the cover removed.

FIG. 9 is a top view of the slicer with the cover and blade set removed.

FIG. 10 is a sectional view taken along line 6-6 of FIG. 1, although depicting the cover removed and the safety comb installed on the blade set.

FIG. 11 is a close-up bottom view of an embodiment of the blade set, safety comb, and body, as viewed from line 11-11 of FIG. 10.

### DETAILED DISCLOSURE

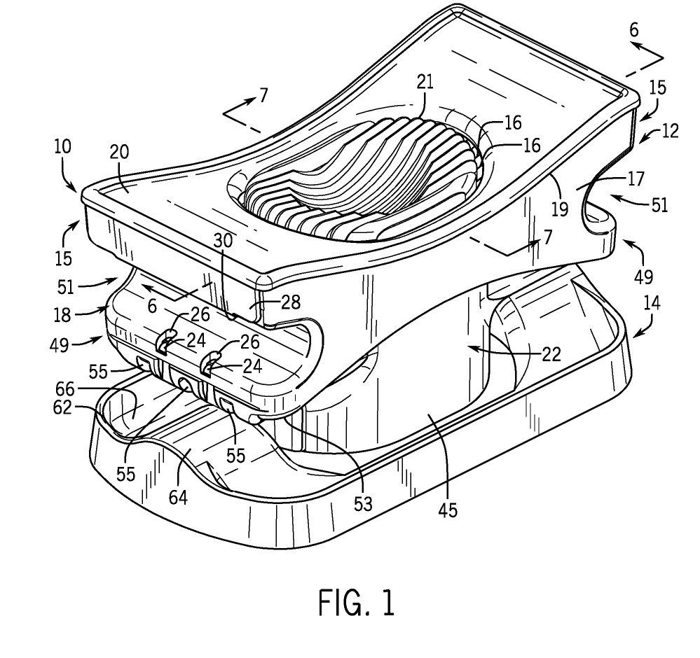

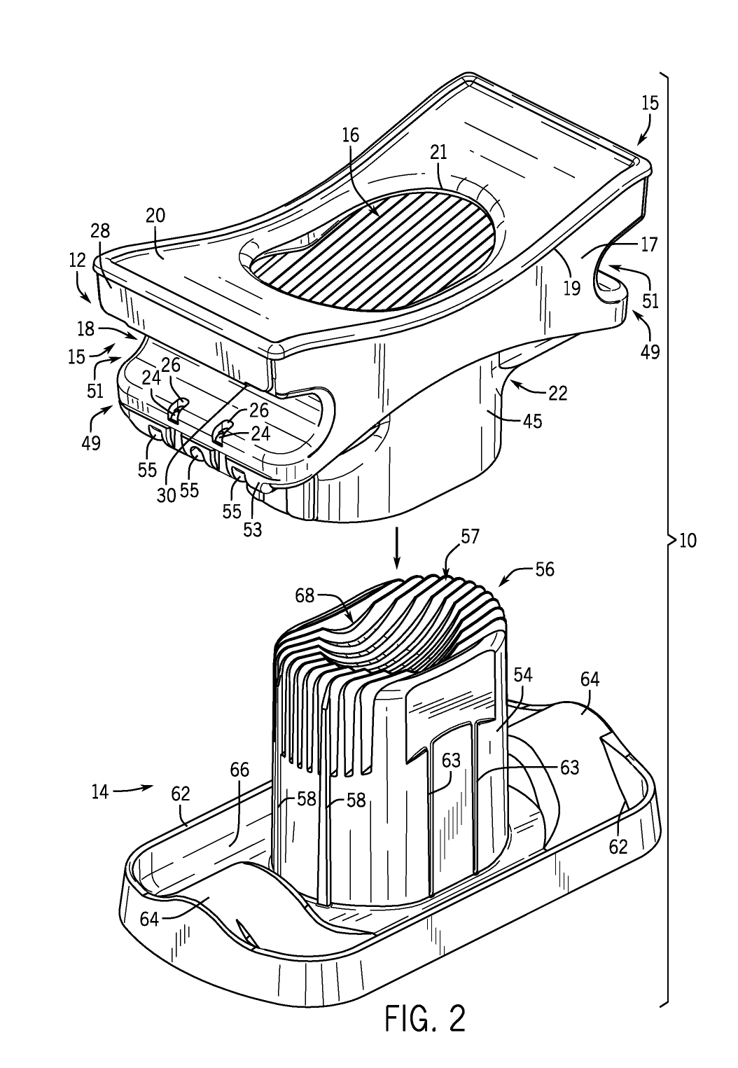

FIGS. 1 and 2 depict an exemplary embodiment of a slicer 10. The slicer 10 is depicted in a closed position in FIG. 1, while the slicer 10 is depicted in an open position in FIG. 2. The slicer 10 is exemplarily configured as a manually operable slicer for slicing a single piece of food at a time. In exemplary, but not limiting, embodiments, the food is a fruit or a vegetable, for example a tomato, cucumber, onion, lettuce, potato, apple, lemon, or orange. In other non-limiting embodiments, the food is a protein, for example a hard boiled egg. While embodiments may be used to slice any of a variety of foods, the present disclosure will use the example of a tomato for reference and clarity without limiting the types of food to be sliced. Still further views of exemplary embodiments of food slicers are depicted in copending U.S. Design Patent Application No. 29/540,080, which is incorporated by reference herein in its entirety.

The slicer 10 includes a head 12 and a base 14. The base 14 supports the food (e.g. tomato) to be cut. The head 12 includes the blades 16 and handles 15 and is brought down over the food to slice the food. In an exemplary embodiment, the head 12 is constructed of three sections, a body 18, a cover 20 and a tube 22. In one embodiment, each of the body 18, cover 20, and tube 22 may be constructed as separate pieces. However, it will be recognized that in other embodiments, some or all of these sections may be wholly or partially integrally formed. In the embodiment depicted, the body 18 and tube 22 are connected together by tabs 24 of the tube 22 which engage holes 26 through the body 18. It will be recognized that other arrangements including, but not limited to reversing the tabs and holes may be used to connect the body and the tube.

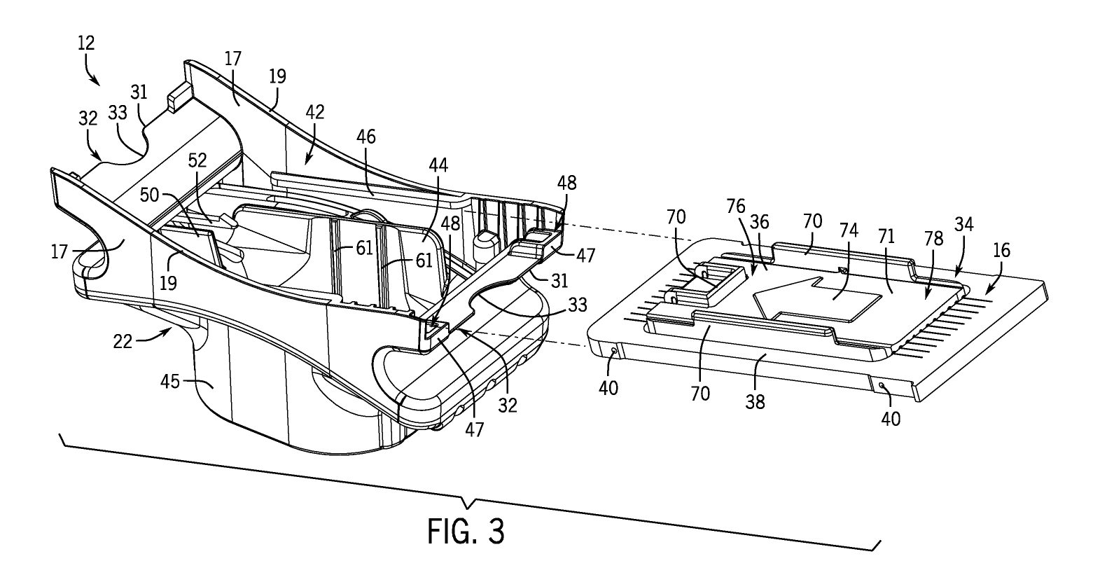

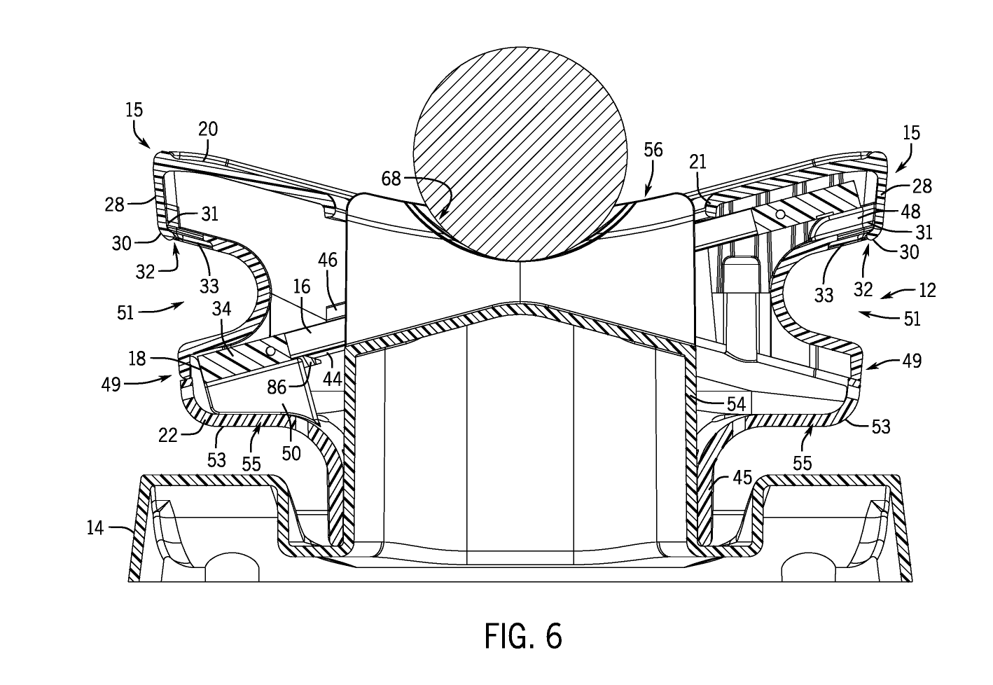

The cover 20 is removably connected to the body 18. The cover 20 is generally concave in profile, being taller relative to the base 14 at the handles 15 and lower at the center near hole 21 through which the blades 16 are exposed. The top edge 19 of the sidewalls 17 of the body 18 are exemplarily concave in shape to correspond to and engagingly fit the cover 20. The hole 21 is exemplarily configured to match the shape of a portion of the base 14 that protrudes therethrough as described in further detail herein. The cover 20 is exemplarily removably connected to the base 18 with arms 28 which end in fingers 30 which engage a lip 31 exemplarily formed by undercut 32 into the body 18 (see e.g. FIGS. 3 and 6). Flexibility in the arms 28 and/or cover 20 enables the arms 28 and/or body 18 to deform or flex outwardly to secure the cover 20 over the body 18 and exemplarily for the arms 28 and fingers 30 to engage the lip 31 in the undercut 32 of the body 18. Removal of the cover 20 from engagement with the body 18 enables access to the interior 42 of the body for placement or removal of the blade set.

FIG. 3 depicts the head 12 with the cover removed and the blade set 34 outside of the head 12. A safety comb 36, as will be described in further detail herein is secured to the blade set 34. The blade set 34 is exemplarily constructed with a frame 38 of a single piece of machined metal between which a plurality of blades 16 extend. The frame 38 is exemplarily placed under a compressive force, and the blades 16 secured to the frame 38 with a pins 40 through the frame 38 and the blades 16 at either end of the blade set 34. While the blade set 34 is depicted and described in use herein, it will be understood that other forms and types of blade sets may be used with other embodiments of the slicer 10. While the blades 16 are depicted as flat, exemplary embodiments may include serrated blades. Non-limiting exemplary embodiments of other blade sets which may be used include the 908, 910, 912, 925, and 943 series of blade sets all currently available from Prince Castle LLC.

The head 12 includes a generally open interior 42. The blade set 34 is secured within the open interior 42 as described in further detail herein and the open interior 42 is configured to receive a portion of the base 14 as will also be described in further detail herein. The head 12 includes support ridges 44 which engage and support the blade set 34 from below. The support ridges 44 are exemplarily a portion of the tube 22 of the head 12 and extend into the body 18 when the tube 22 and body 18 are connected. The head 12 includes lips 46 which engage and support the blade set 34 from above. The lips 46 are exemplarily a portion of the body 18 of the head 12 and extend into the open inter 42 of the head 12 from the sides 17 of the body 18. When the body 18 is secured to the tube 22, a lip 46 of the body 18 and a support ridge 44 of the tube 22 are aligned to receiver the blade set 34 therebetween. The blade set 34 is slid into and out of the head 12 between the lips 46 and the support ridges 44. The head 12 holds the blade set 34 in the open interior 42 at an angle as will be described in further detail herein. In exemplary embodiments, the blade set 34 is held at an angle between 10-20 degrees. In other embodiments, the blade set 34 is held at an angle greater than 20 degrees, while in another embodiment, the blade set 34 is held at an angle of 15 degrees or about 15 degrees. The angle of the blades 16 of the blade set 34 elative to the food to be cut facilitates cutting by reducing the outer surface area of the food being sliced at one time. The outer surface area of the food being sliced often includes a tougher skin relative to the rest of the food.

As further seen in FIG. 3, the head 12 includes two support posts 48 at the end at which the blade set 34 is inserted. These support posts 48 further support the blade set fame 38 at an end of the blade set 34. The support posts 48 further include exterior faces 47 which may exemplarily engage the arms 28 of the cover 20 when the cover 20 is secured to the body 18. The head 12 includes a ledge 50 and fingers 52, which respectively engage the safety comb 36 and the blade set 34 during installation and removal of the blade set 34 as disclosed in further detail herein. In the embodiment depicted, the ledges 50 and the fingers 52 are exemplarily a part of the tube 22 and extend into the body 18.

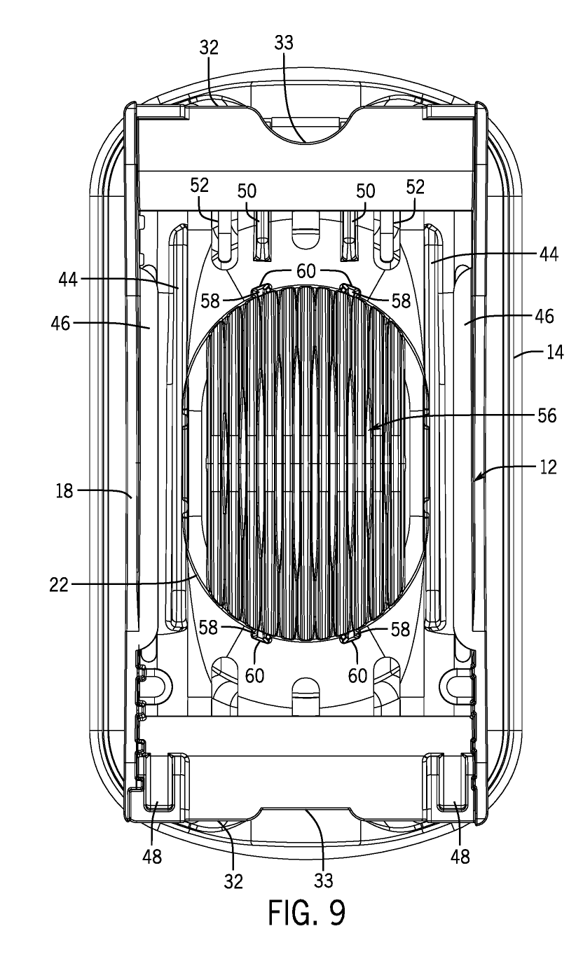

Referring back to FIGS. 1 and 2, the base 14 includes at support tower 54 that extends upwards from the base 14 and ends in a plurality of fins 56. Each of the fins 56 are separated by a slot 57 which are each configured to receive a blade 16 of the blade set therein. The tower 54 is arranged with a corresponding number of slots 57 for each of the blades 16 in the blade set 34 to be used therewith. In an exemplary embodiment, the tower 54 includes at least as many slots 57 (and fins 56 between the slots 57) as there are blades 16 in the blade set. In an additional embodiment, the tower 54 may include more slots 57. The slots 57 represent a small increment or slice size and a corresponding blade set 34 may include fewer blades 16 than the available slots 57. In an example, slots 57 may be spaced apart at ¼ inch increments and may exemplarily be used with blade set with blades spaced ¼ inch or ½ inch apart. The fins 56 are configured to support and retain the piece of food to be sliced, exemplarily a tomato, before, during and after it is sliced by the blades 16 secured within the head 12. The support tower 54 is exemplarily oval or oblong in shape, however, it will be recognized that other shapes of support towers 54 may be used in other embodiments. The tube 22 includes a lower portion 45 which is generally cylindrical in shape. The lower portion 45 is dimensioned to slidingly engage around the support tower 54. It will be recognized that the tower 54 of the base 14 and the lower portion 45 of the tube 22 of the head 12 may be a variety of corresponding shapes, e.g. circular, oval, elliptical, rectangular, or other shapes as will be recognized by a person of ordinary skill in the art. The lower portion 45 may be a cylinder of the shape corresponding to the shape of the tower 54. The hole 21 in the cover 20 of the head 12 may also be a corresponding shape to the lower portion 45 and the tower 54. The support tower 54 may further include tower ridges 58 that are engaged by tube grooves 60 on the interior of the lower portion of the tube 22, which is exemplarily depicted in FIG. 9. The lower portion 45 of the tube 22 similarly may include tube ridges 61 (FIG. 3), and the support tower 54 may include tower grooves 63 (FIG. 2). The tube ridges 61 may slidingly engage the tower grooves 63 for similar alignment purposes.

The base 14 further includes a lip 62 and a rounded elevation 64 that define a trough 66. The trough 66 collects juice, exemplarily from tomatoes as they are sliced by the slicer 10, and channels the juice away from the head 12 and support tower 54.

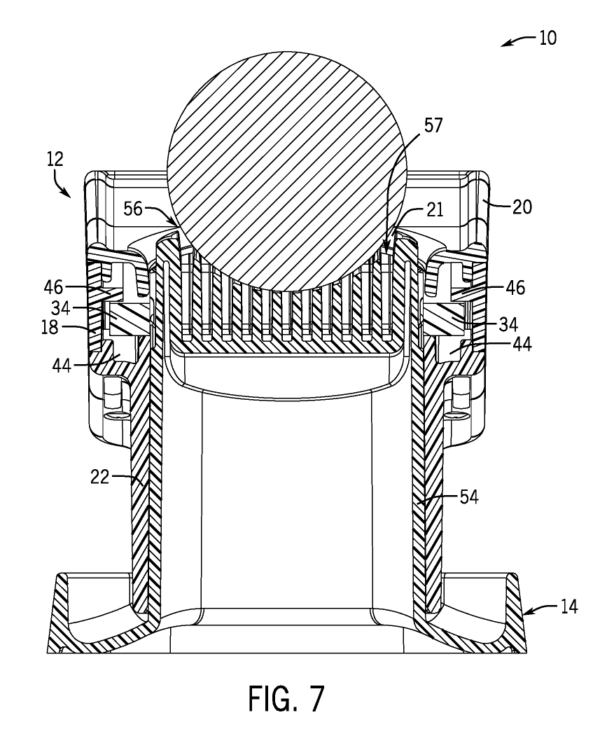

In an embodiment, the fins 56 include a depression 68 that is configured to retain the piece of food to be cut by the slicer 10. In exemplary embodiments, the depression 68 may be shaped to retain a tomato, onion, cucumber, or hard boiled egg. In other embodiments, the depression 68 may be more generalized in shape. In embodiments, the depression 68 is formed by a plurality of curves shaped into the ends of the fins 56. In an embodiment each fin 56 is shaped differently from an adjacent fin to create the depression 68 of the desired shape. In an embodiment, the fins 56 further have a curved profile apart from any depression 68 formed therein. In an exemplary embodiment, the fins 56 have a concave curve across the horizontal (or longer) dimension (FIG. 6) while the fins 56 have a convex curve across the depth (or shorter) dimension (FIG. 7).

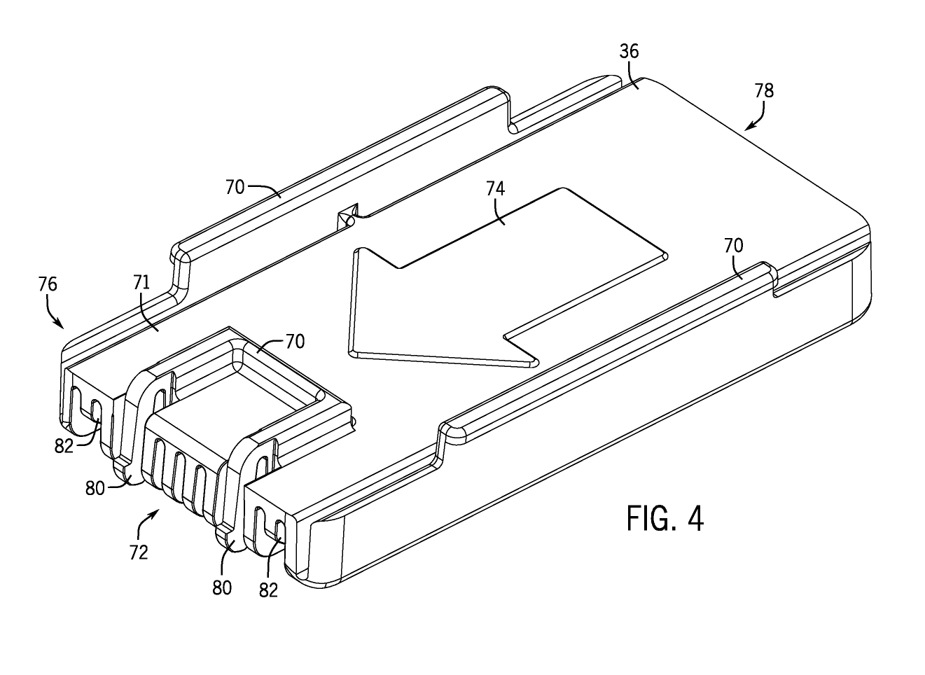

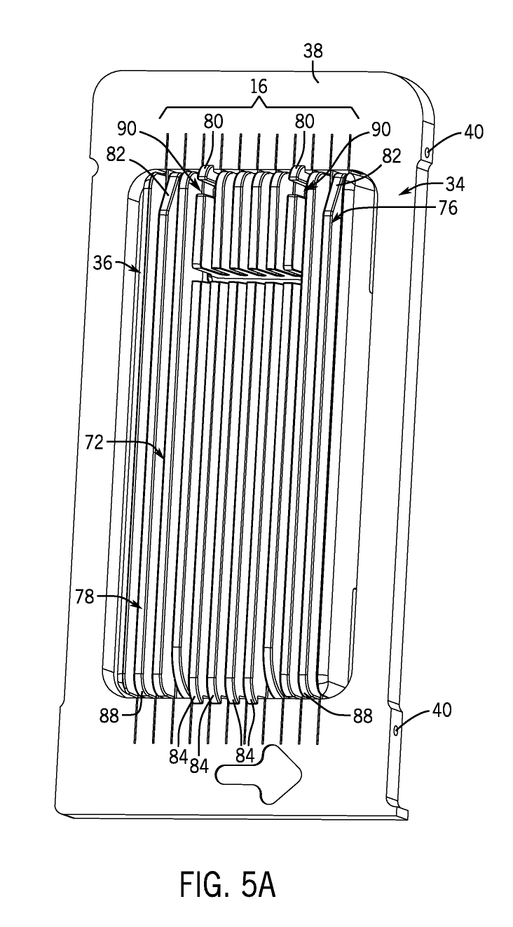

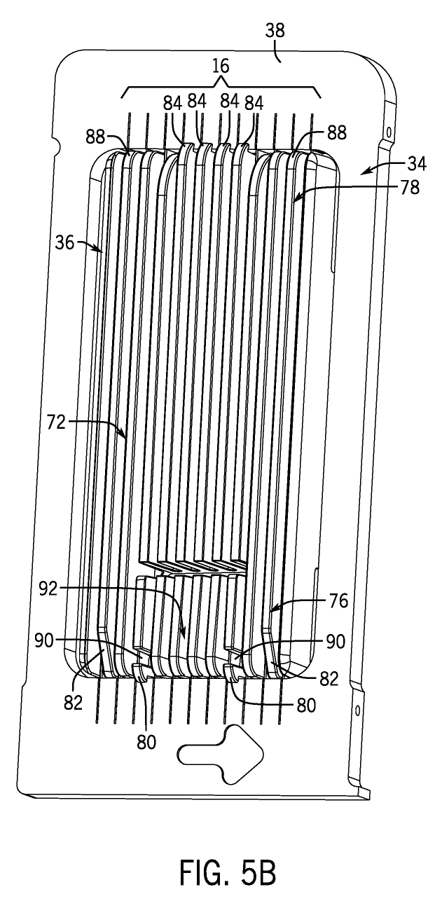

FIG. 4 depicts an exemplary embodiment of the safety comb 36. FIGS. 3, 5A, and 5B depict the safety comb 36 connected to the blade set 34. FIG. 3 provides an exemplary top perspective view. FIG. 5A depicts the safety comb 36 installed on the blade set 34 for insertion of the blade set 34 into the head 12. FIG. 5B depicts the safety comb 36 installed on the blade set 34 for removal of the blade set 34 from the head 12. The safety comb 36 both protects a handler from exposure to the blades 16 in the blade set 34 while also interacting with the head 12 as described in further detail herein to facilitate safe insertion and removal of the blade set 34 from the head 12. The safety comb 36 includes one or more handles 70. In embodiments, handles 70 may be arranged at the sides of the safety comb 36 and/or may be arranged at the front of the safety comb 36. It will be recognized that in other embodiments, fewer or more handles 70 may be provided on the safety comb 36 and such handles may be provided at different locations than those depicted while providing the same function as described herein. The handles 70 facilitate the user securing and/or removing the safety comb 36 from engagement with the blade set 34.

The safety comb 36 includes a plurality of fingers 72 which are arranged to extend between the blades 16 of the blade set 34. When the safety comb 36 is secured over the blade set 34, the fingers 72 extend in between the blades 16 of the blade set 34 to a position extending past the blades 16 and the frame 38 of the blade set 34. By extending past the blades 16, a handler of the blade set 34 is prevented from contacting the sharp sides of the blades 16 while the safety comb 36 is secured in position on the blade set 34. The safety comb 36 is operable to provide safe handling of the blade set 34, insertion and installation of blades sets 34 into the head 12, and safe removal of the blade set 34 from the head 12. As will be described in further detail herein, embodiments of the safety comb 36 are operable to safely move the blade set 34 in the direction as provided by arrow 74 provided on the safety comb 36. Thus, the safety comb 36 includes a front end 76 and a back end 78, exemplarily relative to the arrow 74. The safety comb 36 is configured to move the blade set 34 in the direction of the arrow 74, or in a direction leading with the front end 76. Thus, during installation of the blade set 34 into the head 12, the safety comb 36 is installed on the blade set 34 with the arrow 74 pointing into the head 12. During removal of the blade set 34 from the head 12, the safety comb 36 is installed on the blade set 34 with the arrow 74 pointing out of the head 12.

The front end 76 of the safety comb 36 includes front latches 80 which extend forward from some fingers 72. The safety comb 36 further includes cut outs 82 located in other fingers 72 which extend into the respective fingers 72 of the safety comb 36 (FIGS. 5A, 5B). The cut-outs 82 are exemplarily located in fingers 72 exterior of the fingers 72 which include latches 80. The cut-outs 82 are exemplarily angled surfaces to promote engagement with fingers 52 of the head 12 as described in further detail herein. The back end 78 of the safety comb 36 includes rear latches 84 located on different fingers 72, than the front latches 80. In an exemplary embodiment, the rear latches 84 are located on fingers 72 internally or centrally to the fingers 72 upon which the front latches 80 are located. Exemplarily, as depicted in FIGS. 5A and 5B, the rear latches 84 are located on the central four fingers 72 and the front latches 80 are located on the fingers 72 exterior the central four fingers 72.

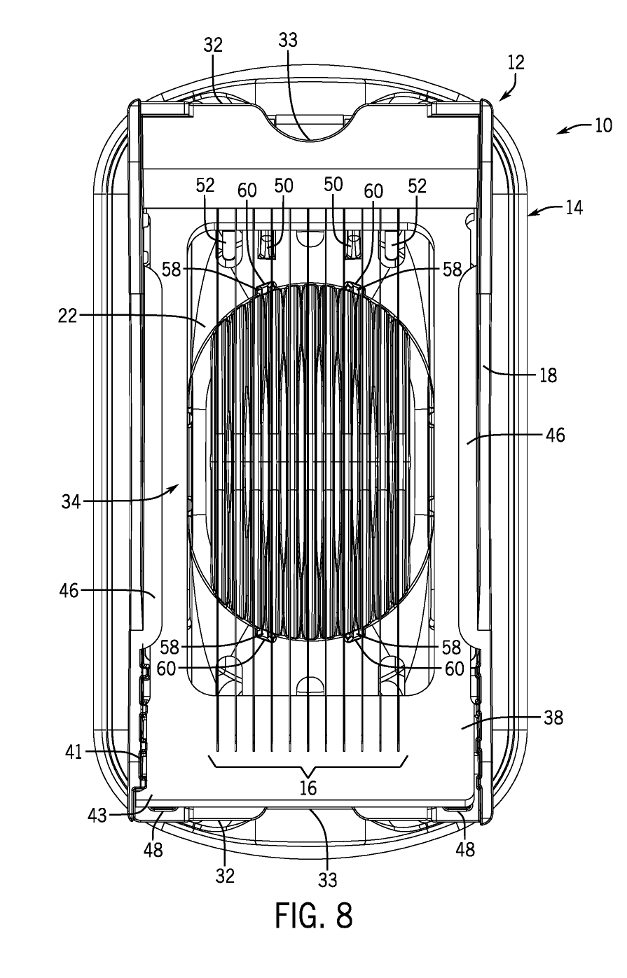

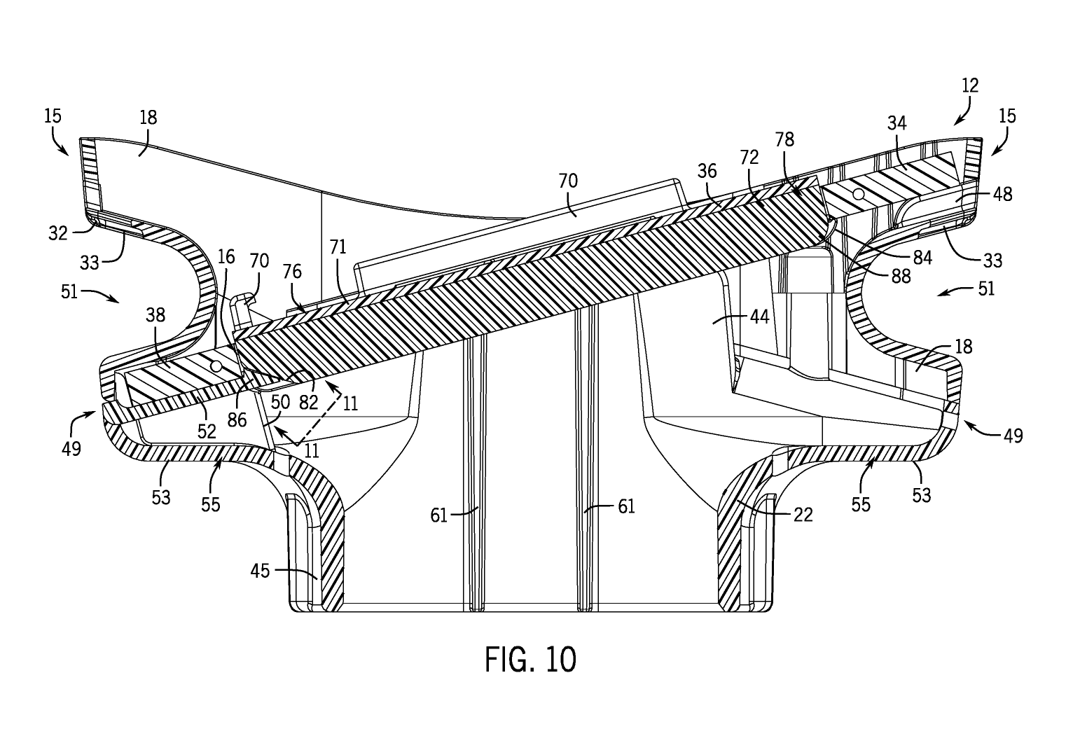

FIG. 10 depicts a cross sectional view of an embodiment of the slicer head similar to that as provided by FIG. 6, although with the safety comb 36 engaging the blade set 34. As can be seen from FIG. 10, the cut outs 82 provide a space which would otherwise be occupied by the finger 72. This space coincides with the area between two blades 16 of the blade set 34 near the frame 38. The fingers 52 of the head 12 are able to extend into this space and engage the frame 38 at a latch end 86 of the finger 52. In an exemplary embodiment, the finger 52 is resiliently deformable and the latch end 86 of the finger 52 is angled such that initial engagement of the frame 38 with the latch end 86 of the finger 52 deflects the finger 52 downwards to permit the frame 38 to pass over the latch end 86 of the finger 52. Once the frame 38 passes the latch end 86, the finger 52 resiliently returns to its previous position and the latch end is free to extend into the space created by the cut out 82 and engage the frame 38. Engagement of the latch end 86 with the inside of the frame 38 secures the blade set 34 into the head 12. It will be recognized that the embodiment depicted in the Figures includes two fingers 52 and latch ends 86. Both of the fingers 52 and latch ends 86 may operate in the way described and in exemplary embodiments may include more or fewer fingers 52 and latch ends 86 than in the described embodiment wile remaining within the scope of the present disclosure. In an exemplary embodiment, engagement of the latch ends 86 with the frame 38 may result in an audible “click” which informs the user that the blade set has been securely installed. Engagement of the latch ends 86 with the frame 38 can also be seen in FIGS. 6 and 8 which depict the blade set 34 installed in the head 12 with the safety comb 36 removed.

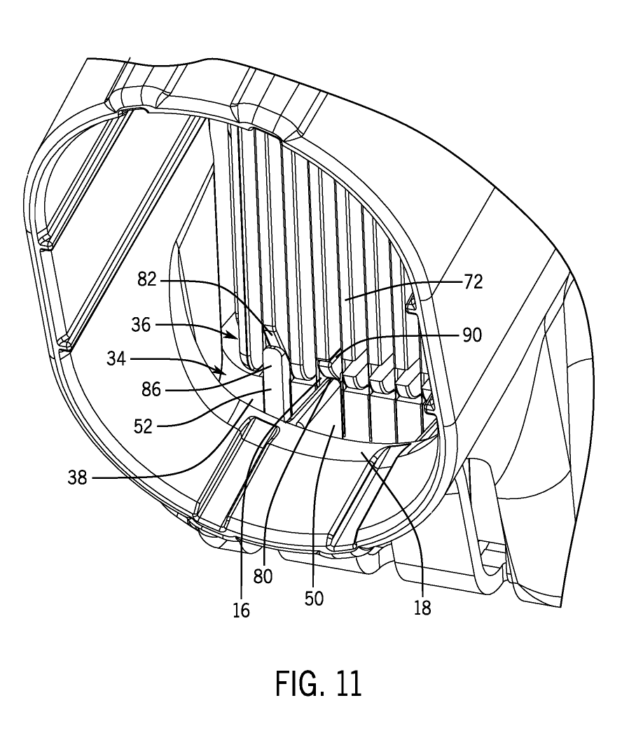

FIG. 11 provides a close up and underneath view as taken along line 11-11 of FIG. 10 of the head 12 with the blade set 34 and safety comb 36 in the position wherein the blade set 34 has been installed in the head 12. As just described, the engagement of the latch end 86 of finger 52 with the frame 38 of the blade set 34 in the space provided by the cut out 82 can be seen. Additionally, concurrently with the engagement of the latch end 86 with the frame 38, the ledge 50 of the head 12 engages the front latch 80 of the safety comb 36 disconnecting the safety comb from engagement with the blade set 34. A space 90 located in the finger 72 behind the front latch 80 enables the front latch 80 to resiliently deform when contacted by the ledge 50. The position of the ledge 50 and the front latch 80 keeps the comb 36 secured to the blade set 34 until a position contemporaneous with the latch ends 86 securing the blade set frame 34 into the head. Upon deformation of the front latches 80, the front end 76 of the safety comb 36 is disengaged from the blade set and the safety comb is pivotably removably from the blade set about the rear latches 84 engaging the blade set frame 38 at the back end 78 of the safety comb.

As best depicted in FIGS. 6 and 10, the head 12 includes a lower projection in either side of the head 12 opposite the handle 15. A finger cavity 51 is formed between the handle 15 and the lower projection 49 and creates a space for a user to place their fingers while gripping the handles 15 with an overhand grip. In an exemplary embodiment, the lower projections 49 are formed by the combined structures of the body 18 and the tube 22. The tube 22 may include tube projection 53 which extend outwards from the lower portion 5 of the tube 22. Drain slots 55 are provided in the tube projections 53 to promote draining and cleaning of the tube projections 53 and the lower projection 49 of the head 12 partially formed by the tube projections 53. As can be seen in the cross sectional view of FIGS. 6 and 10, the interior of the head 12 is generally inwardly slanted and therefore direct cleaning water or solution as well as any food juices or pieces as a result of cutting produce is directed generally out of the lower portion 45 of the tube 22. However, the drain slots 55 (also depicted in fingers 1 and 2) promote cleaning of the interior of the lower projections 49.

As seen in FIGS. 6 and 10, the blade set 34 is positioned within the head 12 at an angle. Exemplarily, the blade set 34 is angled at an angle between 10 degrees and 20 degrees. However, it will be recognized that in other embodiments, greater or smaller angles may also be used. As previously noted, an angled blade relative to the produce and the direction of slicing can improve the slicing the produce to achieve the angulation of the blade set, the blade set 34 is secured to the head 12 within the lower projection 49 while the other end of the blade set 34 is held within the handle 15. Thus, the fingers 52 are located within the lower projection 49 and lock the blade set 34 into position within the head 12 while the blade set is inserted and removed through the handle 15 on the opposing side. This is further facilitated by the support ridges 44 of the tube 22 which supports the blade set 34 from below while the lips 46 of the body 18 retain the blade set 34 from above. Additionally, the body 18, within the handle 15, includes the support post 48 to support the blade set 34 and as best seen in FIG. 8, the body 18 includes a registration block 41 which engages a registration tab 43 of the blade set 34. Engagement of the registration block 41 with the registration tab 43 ensures that the blade set 34 is inserted into the head 12 in the proper direction with the sharp sides of the blades 16 directed towards the lower portion 45 of the tube 22. The registration tab 43 further makes the blade set 34 unidirectional for insertion and removal.

FIGS. 5A and 5B depict bottom perspective views of the safety comb 36 installed on the blade set 34. FIG. 5A exemplarily depicts the safety comb 36 secured to the blade set 34 exemplarily for installation of the blade set 34 into the head 12. FIG. 5B exemplarily depicts the safety comb 36 secured to the blade set 34 exemplarily for removal of the blade set 34 from the head 12. It will be recognized that installation of the safety comb 36 on the blade set 34 for handling or insertion into the head 12 may be carried out by first engaging the rear latches 84 at the back end 78 of the safety comb 36 with the frame 38. Then the safety comb 36 is pivoted about the rear latches 84 to engage the front latches 80 with the frame 38. The front latches 80 may deform inwardly as facilitated by space 90 in the respective fingers 72 which include the front latches 80.

In the removal configuration of FIG. 5B, the safety comb 36 is reversed in orientation to the blade set 34 (compared to FIG. 5A) and exemplarily, the arrow 74 on the safety comb will point in a direction withdrawing the blade set 34 from the head 12. In installation of the safety comb 36 for removal of the blade set 34 from the head 12, the front latches 80 are first engaged with the frame 38 of the blade set 34 and then the safety comb 36 is pivoted about the front latches 80 to move the rear latches 84 into engagement with the frame 38 of the blade set 34. The rear latches 84 are located on fingers 72 which are different from the fingers 72 to which the front latches 80 are located. This facilitates securing the safety comb 36 to the blade set 34 for removal of the blade set 34 from the head 12 because the rear latches 84 are able to engage the frame 38 of the blade set 34 without interference from the ledges 50 of the head 12. As previously described and exemplarily depicted in FIG. 11, the ledges 50 are arranged to engage the front latches 80 and disengage the front latch 80 fro the frame 38. Additionally, as the rear latches 84 engage the blade set 34, respective ends 88 of the fingers 72 that include the cut outs 82 at the front end 76 of the safety comb 36, do not include similar cut outs and therefore those ends 88 engage the latch ends 86 of the fingers 52 and disengage latch ends 86 from the blade set 34. These combined actions both secure the safety comb 36 about the blades 16 of the blade set 34 (with the front latches 80 and the rear latches 84), protecting the user from exposure to the blades while disengaging the blade set 34 from connection to the head 12, with the ends 88 disengaging the latch ends 86 from the frame 38 of the blade set 34. The blade set 34 can then be safely slidably removed from the head 12. The safety comb 36 may be retained on the blade set 34, for example if the blade set is to be safely discarded. Otherwise, the safety comb 36 may be removed from the blade set exemplarily by placing a force on the front handle 70. Spaces 92 located in the fingers 72 at the front end near the front latches 80 facilitate movement of the front latches 80 with a force placed on a front handle 20. This enables removal of the front latches 80 from engagement with the blade set 34.

In an exemplary use of the slicer 10 as disclosed herein, the user places a piece of produce to be sliced in the depression 68 in the fins 56 of the tower 54. The user grips the head 12 by the handles 15 and centers the lower portion 45 of the tube 22 over the tower 54. It is to be noted that the head 12 and the blades 16 may be directional and therefore either 180 degree rotation of the head 12 can be used relative to the base 14. The respective ridges 58, 61 and grooves 60, 63 located in the tube 22 and the tower 54 respectively maintain even alignment of the head 12 relative to the base. A continuous quick downward motion pushes the blades of the head through the piece of produce to be cut. The head 12 stops when the lower portion 45 engages the base 14. The sliced produce can then be removed off of the tower 54 and the head 12 removed from engagements with the base 14 for cutting the subsequent piece of produce.

The shape of the head and the base, as well as placement of draining holes in the head promote cleaning of the head without removal of the blade set. This is a further advantage as the blade set may not be removed from the head accept for instances of replacing the blade set. During blade replacement, the safety comb 36 is used to prevent user contact with the blade and particularly with the cutting side of the blade 16. For replacement of the blade set, the cover 20 is removed from the body 18. The cover 20 is removed by deforming one of the arms 28 and fingers 30 of the cover 20 from out of engagement with the lip 31 provided by the under cut 32 in the body 18.

The safety comb snaps into the blade set for example in the manner as depicted in FIG. 5B. In an embodiment, the rear latches 84 are positioned into engagement with the frame 38 of the blade set 34 and the safety comb 36 pivoted about the engaged rear latches 84 until the front latches 80 similarly engage the frame 38 of the blade set 34 to secure the safety comb 36 to the blade set 34. In this configuration, the arrow 74 on the safety comb 36 points outward from the body 18 in the direction of removal of the blade set 34. As described above, securing the safety comb 36 to the blade set 34 in this manner disengages the latch ends 86 of the fingers 52, releasing the blade set 34 from the body 18 which enables sliding removal of the combined blade set and safety comb from the body 18. This may exemplarily be performed by the user applying force to the handles 70 of the safety comb 36.

A new blade set is installed into the head 12 by securing the safety comb 36 to the new blade set 34 with the arrow 74 of the safety comb 36 pointing in the direction into the head 12. The safety comb 36 is installed as described above with the rear latches 84 first engaging the frame 38 of the blade set 34. Then the safety comb 36 is pivoted about the rear latches 84 until the front latches 80 engage the frame 38 to secure the safety comb 36 to the blade set 34. The combined blade set and safety comb are then inserted into the head 12 in the direction of the arrow 74. When the combined blade set 34 and safety comb 36 are fully into position within the head 12, the ledges 50 inside the head 12 engage the front latches 80 and deform then to disengage them from the frame 38. At the same time, the latch ends 86 of the fingers 52 form around the frame 38 and once the frame 38 has passed the latch ends 86, the latches ends secure the blade set in position with the body 12. With the front latches 80 disengaged from the frame 38 the safety comb 36 can be pivoted out of engagement from the blade set 34 and removed. After installation of the new blade set 34 the cover 20 is reinstalled by hooking the finger 30 of arm 28 against the lip 31 of one of the under cuts and the cover 20 is pivoted into position to secure the other finger and arm to the body 12.

Embodiments of the slicer as disclosed herein provide numerous advantages and features. The support tower holds the piece of food (e.g. tomato) at a elevated position and the depression in the support tower holds the tomato in a position to resist movement as it is sliced. The engagement between the tube 22 and the support tower 54 as well as the alignment features in the tube and support tower ensure that the blades of the head are moved through the tomato to slice the tomato in a consistent and repeatable manner use after use. The top of the support tower is arranged to generally coincide with the top of the cover of the head and the sliced tomato generally remains in place on the support tower after cutting, therefore no additional tray or transfer pan is required for collection of the sliced food. The spaces of the support tower between the fins, in embodiments, is generally convex in shape and the base is further shaped to direct juices away from the cutting area and exemplary into the troughs of the base. This keeps the cutting area free from standing juice, which further facilitates cutting and collection of the cut tomato. The head encloses the blades such that the operator is not exposed to the sharp sides of the blade and holds the blades at an angle to facilitate improved cutting through the tomato. Use of the safety comb as disclosed and described above provides a slicing system wherein the blades may be installed and removed as a blade set in a safe manner by preventing contact between the user and any sharp edges of the blades while also providing a tool that ensures that the blade set is properly installed and held in place before the safety comb can be removed. In a removal operation, the safety comb overcomes the retention features of the head such that the blade set is prevented from being removed without installation of the safety comb.

As previously described above, while not depicted herein, it is recognized that slicers may be configured to perform other types of food slicing, including, but not limited to dicing, cubing, slicing, or wedging. In an exemplary embodiment, a blade cartridge configured to perform a wedge cut, may include exemplarily six or eight angled blades radially extending from a central alignment rod with corresponding wedge-shaped fins on the pusher head. In such an embodiment, the central alignment rod and an exemplary support ring may form the frame for the blade set. In exemplary embodiments, the blades of the blade set may exemplarily be located at different vertical positions relative to one another, which may further reduce cutting surface area. In one embodiment, this may be achieved by two separate blade sets, or a single blade set with blades on different height levels. A non-limiting example of an exemplary construction of a wedging blade is exemplarily found in the 908-A series of heavy-duty wedgers available from Prince Castle LLC.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A slicer comprising:
a base comprising a plurality of fins extending upwards from the base;
a head defining an open interior and movable about the plurality of fins to receive the plurality of fins within the open interior of the head; and
a blade set comprising a plurality of blades, the blade set positioned within the open interior of the head to be received between the plurality of fins when the plurality of fins are received within the open interior of the head.

2. The slicer of claim 1 wherein the base comprises a trough and a tower that extends upwards from the trough and the plurality of fins extend upwards from the tower.

3. The slicer of claim 2, wherein the head comprises a body, a tube, and a cover, wherein the tube is configured to slidingly receive the tower and fins within a lower portion of the tube and cover is removably connected to the body.

4. The slicer of claim 3, wherein the tube comprises at least one of a groove or a ridge and the tower comprises at least one of the other of a groove or a ridge, and the respective groove and the ridge slidingly engage for aligned movement of the head relative to the base.

5. The slicer of claim 3, wherein the head comprises a first handle, a second handle, a first tube projection, and a second tube projection, and a first finger cavity is defined between the first handle and the first tube projection and a second finger cavity is defined between the second handle and the second tube projection.

6. The slicer of claim 5, wherein the blade set is positioned at an angle within the open interior of the head.

7. The slicer of claim 6, wherein the blade set is positioned within the open interior of the head with a first end of the blade set positioned within the first tube projection and a second end of the blade set positioned within the second handle.

8. The slicer of claim 7, wherein the head comprises at least one finger comprising a latch end extending into the open interior of the head from the first tube projection, wherein the at least one finger is resiliently deformable to selectively engage the blade set to secure the blade set within the head.

9. The slicer of claim 8, further comprising:
at least one support ridge within the head, the at least one support ridge configured to engage a frame of the blade set from a side of the blade set closest to the tube; and
at least one lip extending from a side of the head into the open interior of the head, the at least one lip configured to engage the frame of the blade set from a side of the blade set closest to the cover.

10. The slicer of claim 3, wherein the cover, body, and tube are separate components and the cover is releasably secured to the body and the tube is releasably secured to the body.

11. The slicer of claim 3 wherein the tube comprises laterally extending first and second tube projections and the lower portion of the tube extends away from the first and second tube projections, the lower portion of the tube engages the base at the trough.

12. A slicing system comprising:
a slicer comprising a base comprising a plurality of fins extending upwards from the base and a head defining an open interior and movable about the plurality of fins to receive the plurality of fins within the open interior of the head;
a blade set comprising a plurality of blades, the blade set removably received within the open interior of the head at a position to be received between the plurality of fins when the plurality of fins are received within the open interior of the head; and
a safety comb removably secured to the blade set, the safety comb comprising a plate and a plurality of fingers extending away from the plate and adapted to extend between blades of the blade set.

13. The slicing system of claim 12, wherein the blade set is a first blade set and the system further comprises a second blade set, the first and second blade set being interchangeable within the head.

14. The slicing system of claim 12, where the blade set is movable relative to the head to insert and remove the blade set from the open interior of the head.

15. The slicing system of claim 14 wherein the safety comb comprises at least one front latch that extends forward of the safety comb from at least one finger of the safety comb and the safety comb comprises at least one rear latch that extends rearward of the safety comb from at least one finger of the safety comb.

16. The slicing system of claim 15, wherein the safety comb is configured to be removably secured to the blade set by engagement of the at least one front latch and at least one rear latch to the blade set with the at least one front latch oriented in a direction in which the blade set is to be moved.

17. The slicing system of claim 16, wherein the head comprises at least one finger with a latch end, the latch end of the at least one finger configured to releasably secure to the blade set to retain the blade set within the head.

18. The slicing system of claim 17, wherein the safety comb comprises at least one cut out in at least one finger adjacent to the at least one front latch such that the latch end of the at least one finger can secure to the blade set.

19. The slicing system of claim 18 wherein the head comprises at least one ledge adapted to disengage the at least one front latch from the blade set when the blade set is installed and the latch end of the at least one finger is secured to the blade set.

20. The slicing system of claim 17, wherein the fingers of the safety comb adjacent the at least one rear latch engage and deform the at least one finger with the latch end of the head to disengage the latch end from the blade set to facilitate removal of the blade set from the head.
